(19) United States
(12) Patent Application Publication
(10) Pub. No.: US 2024/0278374 A1
(43) Pub. Date: Aug. 22, 2024

(54) METHOD FOR COMPENSATING DEFLECTION OF A TOOL DURING MACHINING OF A WORKPIECE, AND MACHINE TOOL THEREFOR

(71) Applicant: P&L GmbH & Co. KG, Soltau (DE)

(72) Inventor: Jürgen RÖDERS, Soltau (DE)

(21) Appl. No.: 18/569,814

(22) PCT Filed: Jun. 14, 2022
(86) PCT No.: PCT/EP2022/066136

§ 371 Date: Dec. 13, 2023

(30) Foreign Application Priority Data
Jul. 7, 2021 (DE) 10 2021 117 499.6

(51) Int. Cl. B23Q 15/18; G05B 19/404

(52) U.S. Cl. CPC B23Q 15/18; G05B 19/404; G05B 2219/49186

(57) ABSTRACT

The invention relates to a method for compensating deflection of a tool during machining of a workpiece using a machine tool, wherein a control unit of the machine tool balances the compensation of the deflection differently in straight portions (41) and in curved portions depending on a dimension E of engagement conditions in a contact point between the tool and the workpiece, a) on the basis of a ratio of a tool radius R1 and a radius of curvature R2 of the workpiece according to the formula E=R1/R2 and/or b) on the basis of a ratio of a current engagement length L of the tool in the circumferential direction on the workpiece and an engagement length LG of the tool in the circumferential direction on the workpiece during machining of a straight portion of the workpiece according to the formula E=L/LG.

### FIELD OF THE DISCLOSURE

The disclosure relates to a method for compensating deflection of a tool during machining of a workpiece using the tool, and to a machine tool for high-precision machining, which is configured for carrying out the method.

### BACKGROUND OF THE DISCLOSURE

The precision demands on the machining results in cutting milling and grinding machines are constantly increasing. Typically, for machining a workpiece, tools are mounted on a spindle, which tools are set into rotation for the machining process. The cutting process forces occur between the workpiece and the tool during the machining. Said forces lead to deflection of the milling or grinding tool, and consequently to undesired inaccuracies on the produced workpiece. This effect is particularly serious in the case of machining tasks in which circumferential machining of a workpiece is performed, and the tool in particular has a relatively slim shaft. Here, very large deflections of the tool and correspondingly large dimensional deviations on the finished workpiece can occur.

If a deflection of the tool is known for example from experiments, the deflection can be compensated in that a tool path of the tool is corrected by the dimension of the deflection, in the direction of the workpiece. This functions well in the case of straight portions of the workpiece. However, as soon as non-straight portions, for example in the case of circumferential machining having external radii and internal radii, are present, this compensation still leads to imprecise machining results on the workpiece.

### SUMMARY OF THE DISCLOSURE

The present disclosure provides a method for compensating deflection of a tool during machining of a workpiece, which method can be carried out in a simple and cost-effective manner and allows high-precision machining of the workpiece. Furthermore, the disclosure provides a machine tool which is configured for carrying out the method according to the disclosure.

The disclosure relates to a method having the features of claim 1, and a machine tool having the features of claim 15. The dependent claims disclose developments of the disclosure in each case.

The method according to the disclosure having the features of claim 1 has the advantage that exact compensation of a deflection of a tool during machining of a workpiece using the tool is possible. The tool can be a milling tool or a grinding tool. The machining takes place by means of a machine tool, wherein a control unit of the machine tool balances the compensation of the deflection differently in straight portions, internal radii and external radii of the workpiece depending on a dimension E of engagement conditions in a contact point between the tool and the workpiece. In this case, the contact point between the tool and workpiece is defined as the point at which a straight line perpendicular to the workpiece surface intersects a central axis of the tool. In this case, the dimension E is determined on the basis of a ratio of a tool radius R1 to a radius of curvature R2 of the workpiece according to the formula

$$E = R 1 / R 2$$

and/or is determined on the basis of a ratio of a current engagement length L of the tool in the circumferential direction in the workpiece to an engagement length LG of the tool in the circumferential direction in the workpiece during machining of a straight portion of the workpiece according to the formula

$$E = L / LG$$

Thus, the compensation can be determined based on a ratio of the tool radius R1 to the radius of curvature R2, and/or based on a ratio of the current engagement length L to the engagement length LG in straight machining portions. Thus, the method according to the disclosure takes into account whether the machining takes place, at that moment, on straight portions, internal radii or external radii of the workpiece.

The compensation of the deflection of the tool can be balanced particularly well if the control unit takes into account the compensation both based on the tool radius R1 and the radius of curvature R2, and the engagement length L and the engagement length LG on the straight portion, and in particular forms an average.

In some embodiments, the control unit is configured to perform the compensation of the deflection of the tool during machining by means of an adjustment of the relative speed FB between the tool and the workpiece. That is to say that the compensation of the tool deflection is performed by adjusting the relative speed between the tool and the workpiece. This can be implemented in a relatively simple manner by the control unit, and allows for high-precision machining of the workpiece.

In some embodiments, a correction value FB for the speed of the contact point during machining of an external radius of the workpiece is calculated
a) using the formula

$$FB = FB 0 + FK \cdot {E}^{k}$$

with the dimension E as the ratio of the tool radius R1 to the radius of curvature R2, wherein FB0 is a value for the speed of the contact point on the straight portion, FK is a first correction constant, and k is a second correction constant, and/or
b) using the formula

$$FB = FB 0 + FK \cdot {( 1 - E )}^{k}$$

with the dimension E as the ratio of the current engagement length L to the engagement length LG on the straight portion, wherein FB0 is a value for the speed of the contact point on the straight portion, FK is a first correction constant, and k is a second correction constant.

In some embodiments, a correction value FB is calculated during machining of an internal radius of the workpiece, for the speed of the contact point,
a) using the formula

$$FB = FB 0 - FK \cdot {E}^{k}$$

with the dimension E as the ratio of the tool radius R1 to the radius of curvature R2, wherein FB0 is a value for the speed of the contact point on the straight portion, FK is a first correction constant, and k is a second correction constant, and/or
b) using the formula

$$FB = FB 0 - FK \cdot {( E - 1 )}^{k}$$

with the dimension E as the ratio of the current engagement length L to the engagement length LG on the straight portion, wherein FB0 is a value for the speed of the contact point on the straight portion, FK is a first correction constant, and k is a second correction constant.

Thus, the control unit can be configured to calculate the compensation of the deflection of the tool by an adjustment of a relative speed FB between the workpiece and the tool, in the case of an external radius by means of two calculation methods, and in the case of an internal radius to likewise calculate this by means of two calculation methods. A precision of the machining can be increased if, for an external radius or an internal radius, in each case both alternative calculation methods are carried out, in order to adjust the speed of the contact point to the deflection of the tool.

In some embodiments, the control unit is configured to perform the compensation of the deflection of the tool during machining by means of a correction of a tool path.

In some embodiments, a correction value S for the tool path during machining of an external radius is calculated
a) using the formula

$$S = SG - SR \cdot {E}^{k}$$

with the dimension E as the ratio of the tool radius R1 to the radius of curvature R2, wherein SG is the correction value for the tool path on straight portions of the workpiece, SR is a first correction constant, and k is a second correction constant, and/or
b) using the formula

$$S = SG - SR \cdot {( 1 - E )}^{k}$$

with the dimension E as the ratio of the current engagement length L to the engagement length LG on the straight portion, wherein SG is a correction value for the tool path on straight portions of the workpiece, SR is a first correction constant, and k is a second correction constant.

In some embodiments, a correction value S for the tool path during machining of an internal radius is calculated
a) using the formula

$$S = SG + SR \cdot {E}^{k}$$

with the dimension E as the ratio of the tool radius R1 to the radius of curvature R2, wherein SG is a correction value for the tool path on straight portions of the workpiece, SR is a first correction constant, and k is a second correction constant, and/or
b) using the formula

$$S = SG + SR \cdot {( E - 1 )}^{k}$$

with the dimension E as the ratio of the current engagement length L to the engagement length LG on the straight portion, wherein SG is a correction value for the tool path on straight portions of the workpiece, SR is a first correction constant, and k is a second correction constant.

Thus, a correction of a tool path in the case of a deflection of the tool can take place, in the case of an external radius, by means of two calculation methods, and in the case of an internal radius can likewise take place by means of two calculation methods. In order to increase the precision, for the external radius and the internal radius in each case both calculation methods can be carried out simultaneously, and the in particular an average can be formed.

In some embodiments, the method according to the disclosure uses a combination of the calculation of the compensation value for the deflection, in which a correction of the tool path and a correction of the relative speed between the tool and the workpiece are combined. Particularly high-precision machining of the workpiece is then possible.

The correction values for determining the adjustment of the relative speed between the tool and workpiece, and/or the correction of the tool path, can be determined empirically. In this case, different first and second correction constants for internal radii and external radii can also be provided.

In some embodiments, for the compensation, the method according to the disclosure takes into account a course of the workpiece surface still to be machined. As a result, particularly high-precision machining of workpieces can take place, since in particular in the case of a change in the geometry of the workpiece surface, for example from a straight portion into a portion having an internal radius or external radius, or vice versa, or a change in the curvature of a curved portion, compensation is possible even before the actual transition point between the geometrically different workpiece surfaces is reached. Thus, for example prior to reaching a transition point on the workpiece from the transition of a straight portion into a portion having a radius, a relative speed between the tool and the workpiece and/or a tool path can be adjusted. As a result, in particular high-precision machining at the transition points in the case of geometry changes of the workpiece is possible.

The method according to the disclosure can be carried out in the case of circumferential machining of workpieces, wherein both an outer circumference and an inner circumference can be machined. The method according to the disclosure can be used in the case of spherical surfaces too.

In order to allow even machining of the workpiece with even higher precision, the control unit is furthermore configured to carry out the compensation of the deflection of the tool taking into account a length of the tool in the axial direction of the tool, and/or to carry it out taking into account a geometry of the tool shaft, and/or to carry it out taking into account an axial engagement length of the tool in the axial direction of the tool in the workpiece.

In some embodiments, the first correction constant and/or the second correction constant are dependent on the tool geometry, in particular the diameter, the shaft geometry, the cutting length, etc., the type of the tool, the quality of the cutting edges of the tool, the material of the cutting edges, in particular a granularity in the case of a grinding tool, the oversize of the workpiece, the rotational speed of the workpiece, the speed of the contact point between the workpiece and the tool, and/or the material of the workpiece.

The correction constants FK, SR and k can be the same for all formulas.

In some embodiments, the control unit comprises a memory in which values for the correction constants are stored.

In some embodiments, the control unit is configured to perform the compensation of the deflection of the tool by means of a learning system for the correction constants. As a result, the precision in the compensation of the deflection of the tool can be improved over time.

A further increase in the machining precision is possible if, for example before the final machining of the workpiece, an oversize still present on the workpiece (actual workpiece) is measured. The oversize can be measured in a clamp in the machine tool, or alternatively in a separate measuring machine. In this case, the oversize on the actual workpiece, which is to be removed, generally depends on prior processing. In prior processing too, however, different tool deflections may occur. If these have not been compensated, the oversize for the machining of the actual workpiece may not be constant. Therefore, prior to the final machining of the actual workpiece the precision can be significantly improved by means of a measurement of the actually exciting oversize, in particular if the measured oversize is consulted for the calculation of the current engagement length L for each tool position on the workpiece. In some embodiments, a thickness of the oversize of the workpiece is measured at any number of points on the workpiece, in particular measured fully, prior to a final machining. If the dimension E is calculated as the ratio of the tool radius R1 to the radius of curvature R2, the first correction constant FK for the speed and/or the first correction constant SR for the tool path and/or the second correction constant k can be determined depending on the oversize on the workpiece that is actually to be removed.

In some embodiments, the method according to the disclosure is used in a grinding method using a cylindrical grinding tool, which performs a rapid stroke in the axial direction of the tool. During said rapid stroke machining, the tool is simultaneously moved relative to the workpiece only slowly along the contour of the workpiece.

The correction of the tool path for compensating the deflection of the tool has the advantage, compared with the adjustment of the relative speed of the contact point, that the correction of the tool path has only a very slight influence on the duration of the machining of the workpiece. A change in the relative speed between the tool and the workpiece can result in lengthening of the machining time.

The present disclosure furthermore relates to a machine tool which is configured to carry out the method according to the disclosure. The machine tool can be configured for rapid stroke machining using a cylindrical grinding tool.

The machine tool can comprise a control unit and a memory, in which all the tools to be used in the machine tool are saved, together with their individual parameters and correction constants.

In order not to have to input all the parameters and correction constants again, for each individual tool, upon each machining operation, tool types can be defined, for which all the parameters and correction constants are specified. If, for example, a tool is then worn and has to be replaced for a new tool, the new tool is configured identically to the old tool, i.e. having the same tool holder, same machining tool, same protrusion length, etc., and can thus be assigned to the same tool type, having the same parameters and correction constants, as the previously worn tool. Thus, a set of tool types can be defined, which are used here in the machine tool.

In some embodiments, for each tool in the machine tool and/or for each tool type used, the parameters that are dependent on the geometry of the tool, which parameters are relevant for determining the dimension E for the engagement conditions for deviation compensation, are stored in the memory (tool database). In some embodiments, in addition all further relevant parameters for the engagement conditions, such as rotational speed, oversize to be removed, first and second correction constants, workpiece material/workpiece properties, and/or temperature in the working space, can be stored.

In some embodiments, all parameters and correction constants are stored in the controller, for different machining processes. If two different machining processes are carried out in the machine using one tool, e.g. on workpieces made of different material or having a different oversize, the parameters and correction constants can be stored separately, in the controller, for the different machining processes, such that each machining process can be used separately, with the associated parameters and correction constants. Parameters and correction constants are thus stored not only in a tool-based, manner but rather also in a process-dependent manner, for different machining situations.

### BRIEF DESCRIPTION OF THE DRAWINGS

Embodiments are described in detail in the following, with reference to the accompanying drawings, in which:

FIG. 1 is a schematic, perspective view of a machine tool configured for carrying out the method according to the disclosure according to a first embodiment of the disclosure,

FIG. 2 is a schematic side view of a tool that is engaged with a workpiece, the deflection of the tool being shown exaggerated,

FIG. 3 is a schematic view of machining of a workpiece on a straight portion of the workpiece,

FIG. 4 is an enlarged partial view of FIG. 3,

FIG. 5 is an enlarged partial view of FIG. 3, showing machining on an external radius of the workpiece,

FIG. 6 is an enlarged partial view of machining on an internal radius of the workpiece,

FIG. 7 is a schematic view showing the compensation of a deflection of a tool, with a correction of the tool path on an external radius, and

FIG. 8 is a schematic view showing the compensation of a deflection of a tool, with a correction of the tool path on an internal radius.

### DETAILED DESCRIPTION

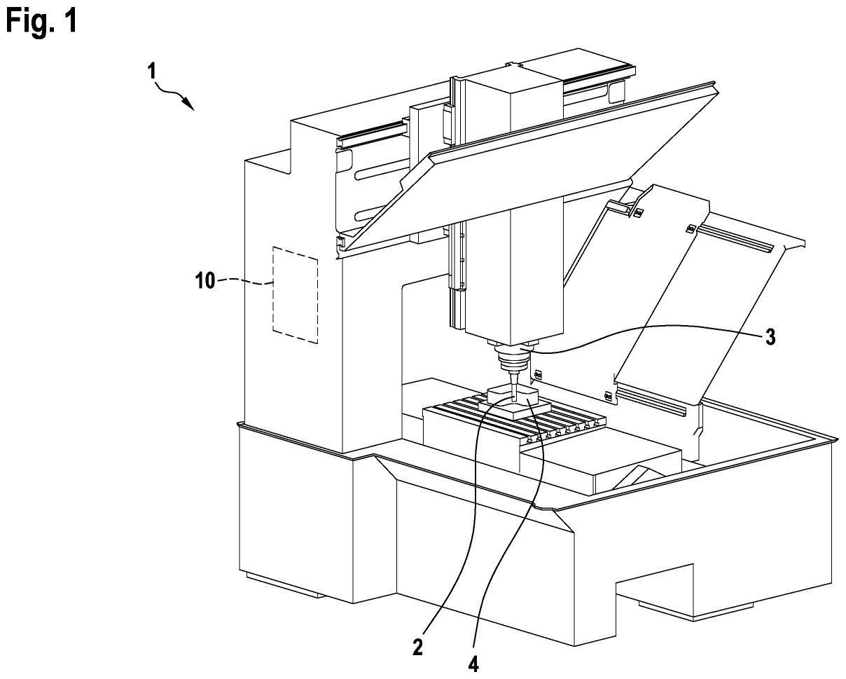

Various embodiments of the disclosure are described in detail in the following, with reference to FIGS. 1 to 8.

FIG. 1 schematically shows a machine tool 1 which is configured for carrying out the method according to the disclosure. The machine tool 1 comprises a control unit 10 which is configured for compensating a deflection of a tool 2 during machining of a workpiece 4. The tool 2 is rotatably clamped in a spindle 3 by means of a tool holder 9. In this embodiment, the tool 2 is a grinding pin.

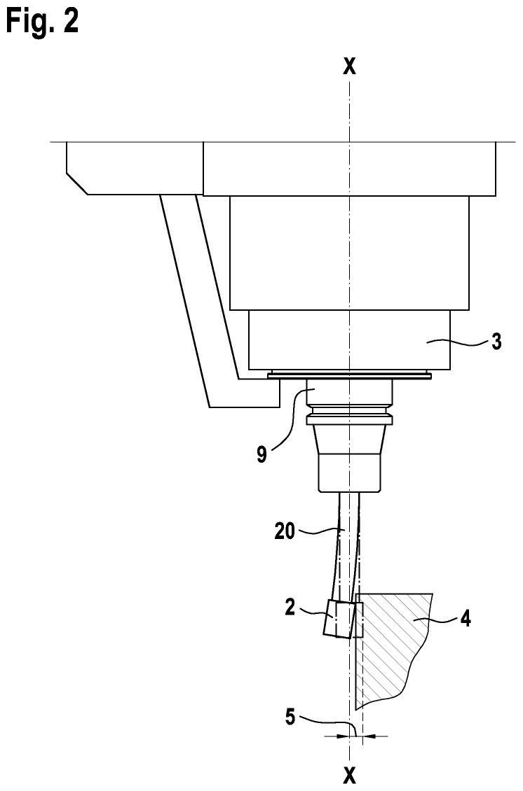

FIG. 2 schematically, and in an exaggerated manner, shows the possible deflection of the tool 2 upon engagement in the workpiece 4. In this case, the deflection 5 is defined as the lateral displacement of the tool 2 from the typical vertical alignment of the tool 2 in its central axis X-X.

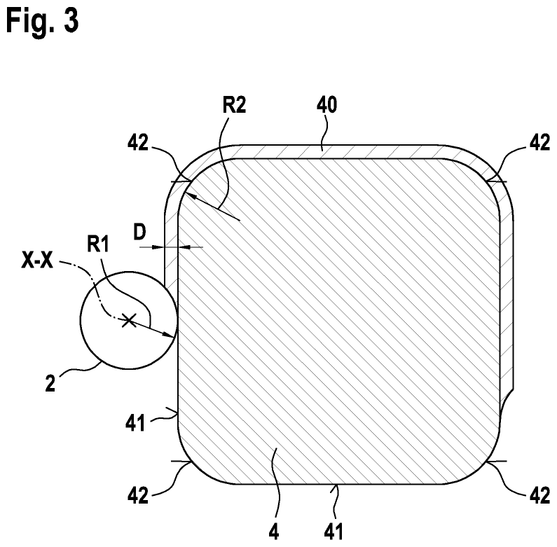

FIG. 3 is a schematic plan view showing machining of a workpiece 4 using a tool 2. In this case, the workpiece shown still has an oversize 40 having a thickness D. Thus, FIG. 3 shows an actual state of the workpiece (actual workpiece). The workpiece 4 to be produced (target workpiece) is achieved when the entire oversize 40 has been removed by means of the tool 2.

The tool 2 in FIG. 3 has a tool radius R1. The target workpiece 4 comprises straight portions 41 and portions 42 having external radii having a radius of curvature R2.

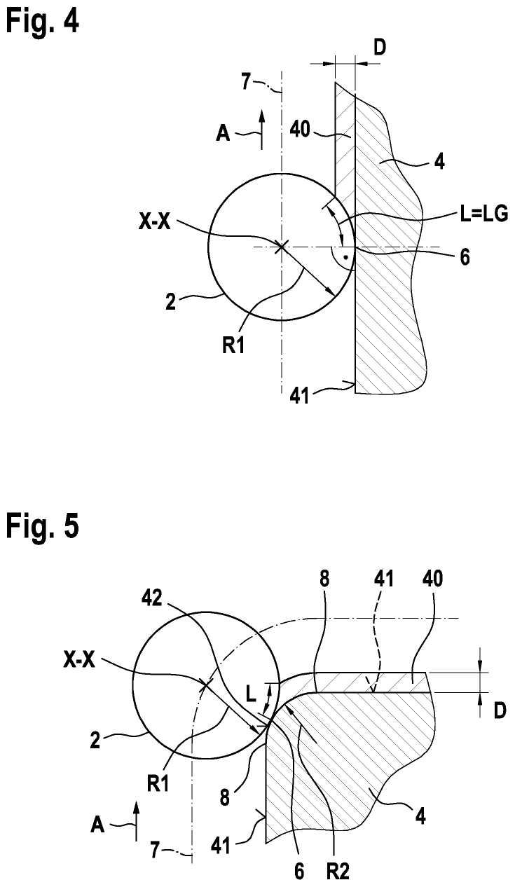

FIG. 4 schematically shows an engagement state of the tool 2 on a straight portion 41 of the workpiece 4. In this case the oversize 40 is removed from the actual workpiece. Furthermore, a contact point 6 is indicated in FIG. 4. The contact point 6 is defined as the point at which the tool 2 contacts the workpiece 4, wherein a vertical line passes from the workpiece surface through a central axis X-X of the tool 2.

Furthermore, FIG. 4 shows a current engagement length L between the tool 2 and the oversize 40 of the workpiece 4. Since in this example the current engagement length L of the tool 2 on the workpiece 4 corresponds to an engagement length LG of the tool 2 in the circumferential direction in the oversize 40 on the workpiece 4 during machining of a straight portion 41 of the workpiece 4, then L=LG.

Furthermore, FIG. 4 shows a tool path 7 in which the control unit 10 has already carried out the necessary compensation of the deflection of the tool 2 during engagement with the workpiece 4. Since in FIG. 4 a straight portion 41 of the workpiece 4 is machined, the tool path 7 is linear and in parallel with the straight portion 41.

FIG. 5 schematically shows an engagement of the tool 2 in a curved portion of the workpiece 4 on an external radius 42 having a radius of curvature R2. In this case, the contact point 6 is already located on the curved portion of the workpiece 4.

Furthermore, a current engagement length L between the tool 2 and the oversize 40 of the workpiece 4 is indicated in FIG. 5. In this case, the current engagement length L indicated is smaller than the engagement length LG, shown in FIG. 4, on the straight portion 41, since the tool 2 is already machining the external radius 42, and the thickness D of the oversize 40 on the straight portion 41 and on the external radius 42 is the same.

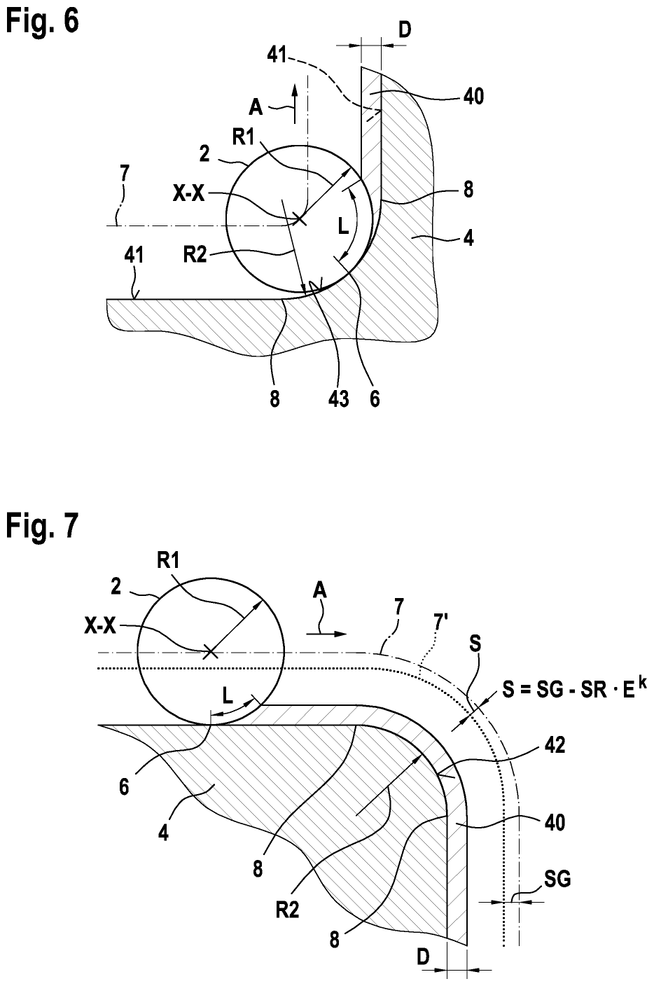

FIG. 6 schematically shows a machining situation on the internal radius 43 having an internal radius R2. In this case, the contact point 6 is located in the region of the internal radius 43. Furthermore, a current engagement length L is indicated schematically in FIG. 6. As is clear from FIG. 6, on account of the already machined internal radius 43, the current engagement length L is greater than the engagement length LG, shown in FIG. 4, on the straight portion 41, also because again the thickness D of the oversize 40 on the straight portion 41 and on the internal radius 43 is the same.

In FIGS. 4 to 6, in each case the same tool 2 having the same tool radius R1 is shown, which tool in each case mills or grinds oversizes 40 of the same thickness D. As is directly clear from a comparison of FIGS. 4, 5 and 6, the current engagement length L in each case is dependent on the geometry of the surface, to be machined, on the workpiece 4. In the case of an internal radius 43, the current engagement length L is greater than the engagement length LG on the straight portion 41 (FIG. 6). In the case of machining of an external radius 42 (FIG. 5), the current engagement length L is smaller than the engagement length LG on the straight portion 41. Accordingly, a changed compensation of the deflection of the tool 2 upon engagement with the workpiece 4 has to take place.

FIG. 7 shows, in detail, the compensation of the deflection of the tool 2 during machining on the external radius 42. In this case, reference character 7 denotes, in the dot-dashed line, the tool path without compensation. The reference character 7′ shows, in exaggerated form, the tool path with compensation. As is clear from FIG. 7, in the case of the tool path 7′ with compensation, the tool path 7′ for the tool 2 is less significantly corrected in the region of the external radius 42 compared with on the straight portion 41. The distance between the compensated tool path 7′ and the non-compensated tool path 7 is smaller in the region of the external radius 42 than on the straight portion 41. As a result, it is possible to more precisely compensate the deflection of the tool 2 during machining of the external radius 42.

FIG. 7 shows, by way of example, the method according to the disclosure for compensating a deflection of a tool 2 during machining of the workpiece 4 on an external radius 42. The workpiece 4 still has an oversize 40, which is to be removed by the tool 2, in order to produce a desired target workpiece without oversize 40. The tool 2 is in engagement with the workpiece 4 and moves in the direction of the arrow A on a predetermined tool path 7′.

In order to prevent the desired target state of the workpiece 4 being produced on the external radius 42, a compensation of the deflection of the tool 2 takes place. In this embodiment, the compensation of the deflection of the tool 2 is intended to be carried out by means of a correction of the tool path 7. This can be carried out essentially in two ways, as described below, wherein the compensation types can also be combined with one another. Therefore, for correction of the tool path 7, a correction value S for the tool path is calculated using the formula

$$S = SG - SR \cdot {E}^{k} \qquad ( Formula 1 )$$

wherein SG is the correction value for the tool path 7 on a straight portion 41 of the workpiece, SR is a first correction constant, and k is a second correction constant. A value for the dimension E of engagement conditions in the contact point 6 between the tool 2 and workpiece 4 is then calculated by the ratio of the tool radius R1 to the radius of curvature R2 of the external radius 42: E=R1/R2.

This compensation according to formula 1 is shown in FIG. 7. The original tool path 7 and a tool path 7′ which takes into account the compensation of the deflection of the tool 2 extend in parallel on the straight portions 41 of the workpiece 4. In this case, the tool path 7′ with compensation of the deflection extends somewhat closer to the workpiece 4. In the region of the external radius 42, however, the distance between the original tool path 7 and the tool path 7′ with compensation of the deflection changes.

The second alternative for calculation of a correction value S for the tool path 7 for the external radius 42 can be calculated using the formula

$$S = SG - SR \cdot {( 1 - E )}^{k} \qquad ( Formula 2 )$$

wherein SG is the correction value for the tool path 7 on a straight portion 41 of the workpiece 4, SR is a first correction constant, and k is a second correction constant. In this case, the dimension E for engagement conditions in the contact point 6 between the tool 2 and workpiece 4 is calculated by means of the ratio of the current engagement length L to the engagement length LG on the straight portion 41: E=L/LG.

In order to increase the precision during the compensation of the deflection of the tool 2, both the above-mentioned formulas 1 and 2 can be used, and an average can be formed for the compensation.

In order to further increase the precision, in the case of the machining of the external radius 42, a compensation of the deflection of the tool 2 by means of an adjustment of a relative speed between the tool 2 and workpiece 4 can be carried out. In this case, a speed FB of the contact point 6 can be calculated using the formula

$$FB = FB 0 + FK \cdot {E}^{k} \qquad ( Formula 3 )$$

wherein FB0 is the speed of the contact point 6 on a straight portion 41, FK is a first correction constant, and k is a second correction constant. The dimension E is calculated by means of the ratio of the tool radius R1 to the radius of curvature R2: E=R1/R2.

Alternatively or in addition, for a calculation of a speed FB of the contact point 6 this can also be calculated using the formula

$$FB = FB 0 + FK \cdot {( 1 - E )}^{k} \qquad ( Formula 4 )$$

wherein FB0 is the speed of the contact point 6 on a straight portion 41, FK is a first correction constant, and k is a second correction constant. The dimension E is calculated by means of the ratio of the current engagement length L to the engagement length LG on the straight portion 41: E=L/LG.

In this case, in order to increase the precision a combination of both the above-mentioned formulas 3 and 4 is also possible, for adjusting the speed for the compensation of the deflection of the tool 2.

Of course, the two calculation methods (formula 3 and 4) for the correction of the speed FB of the contact point 6 and the two calculation methods (formula 1 and 2) for the correction of the tool path 7 can be combined with one another, and the compensation can be carried out simultaneously by means of an adjustment of the relative speed between the tool 2 and the workpiece 4, and a correction of the tool path 7.

Thus, a compensation of the deflection of the tool 2 on the external radius 42 can be carried out by two calculation methods relating to an adjustment of a relative speed of the contact point 6 and/or by two calculation methods for correcting a tool path 7, wherein any combinations of the calculation methods are possible.

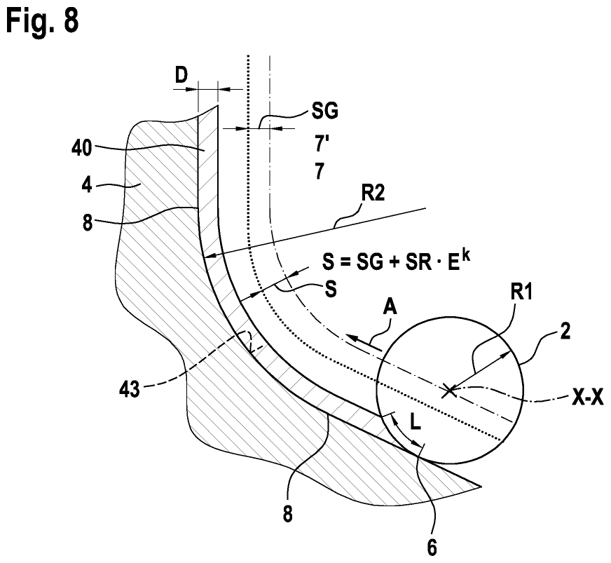

FIG. 8 schematically shows a compensation of the deflection of the tool 2 during machining of the workpiece 4 on an internal radius 43 of the workpiece 4. In the case of the compensation of the deflection on an internal radius 43, too, there are in principle four different possibilities for calculation, wherein two calculation methods relate to the correction of the tool path 7 for compensation of the deflection, and two calculation methods relate to the adjustment of the relative speed between the workpiece 4 and the tool 2 at the contact point 6.

For the correction of the tool path 7 in the case of an internal radius 43, a compensation of the deflection of the tool 2 can be calculated by calculating a correction value S for the tool path 7 using the formula

$$S = S G + SR \cdot {E}^{k} \qquad ( Formula 5 )$$

wherein SG is the correction value for the tool path 7 on straight portions 41, SR is a first correction constant, and k is a second correction constant. In this case, a value for the dimension E of engagement conditions in the contact point 6 between the tool 2 and workpiece 4 is calculated by the ratio of the tool radius R1 to the radius of curvature R2 of the internal radius:

$$E = R 1 / R 2.$$

FIG. 8 shows the compensation of the original tool path 7 using formula 5, and, as the result, in an exaggerated illustration a tool path 7′ for compensation of the deflection of the tool 2 compared with on the internal radius 43. On the straight portions 41 of the workpiece 2, the two tool paths 7, 7′ extend in parallel with one another, wherein the correction value SG for the tool path 7 on straight portions 41 is indicated. In order to balance the deflection of the tool 2, the corrected tool path 7′ is brought closer to the workpiece 4, by the compensation of the deflection in the region of the internal radius 43, in order to ultimately achieve a correct contour of the target workpiece 4 to be produced. In this case, the correction of the tool path 7 is calculated using formula 5.

Alternatively or in addition, a correction of the tool path 7 can also be calculated using the formula

$$S = S G + SR \cdot {( E - 1 )}^{k} \qquad ( Formula 6 )$$

wherein SG is the correction value for the tool path 7 on straight portions 41, SR is a first correction constant, and k is a second correction constant. The dimension E is the ratio of the current engagement length L to the engagement length LG on the straight portion 41: E=L/LG.

In this case, it is also possible for the correction of the tool path 7 for compensation of the deflection to take place by a combination of the two calculation methods (formula 5 and 6) and forming an average.

Alternatively, in the case of an internal radius 43, an adjustment of a relative speed between the tool 2 and workpiece 4 can also be carried out. In this case, a speed FB of the contact point 6 can be calculated using the formula

$$FB = FB 0 - FK \cdot {E}^{k} \qquad ( Formula 7 )$$

wherein FB0 is the speed of the contact point 6 on a straight portion 41, FK is a first correction constant, and k is a second correction constant. The dimension E is determined by the ratio of the tool radius R1 to the radius of curvature R2: E=R1/R2.

Alternatively, a correction for the speed FB of the contact point 6 in the case of an internal radius can be calculated using the formula

$$FB = FB 0 - FK \cdot {( E - 1 )}^{k} \qquad ( Formula 8 )$$

wherein FB0 is the speed of the contact point 6 on a straight portion 41, FK is a first correction constant, and k is a second correction constant. The dimension E is determined by the ratio of the current engagement length L to the engagement length LG on the straight portion 41:

$$E = L / LG .$$

In the case of the adjustment of the speed FB in the case of an internal radius 43, too, it is possible for the two formulas 7 and 8 to be combined with one another. Furthermore, it is possible that, in the case of the compensation of the deflection of the tool 2 on the internal radius 43, a combination of two or three or of all four of the above-mentioned formulas 5, 6, 7 and 8 is carried out.

Regarding FIGS. 7 and 8, it is noted that in the case of the calculation of the dimension E, preferably a positive value for the radius R2 of the workpiece 4 is used, irrespective of whether it is an internal radius or an external radius.

With regard to the first correction constant FK and the second correction constant k, it is furthermore noted that the correction constants for an internal radius 43 and an external radius 42 can be different. As a result, a greater precision in the compensation of the deflection of the tool is achieved.

In this respect, according to the disclosure a compensation of a deflection of the tool 2 during machining of the workpiece 4 depending on the geometry of the workpiece 4, in particular depending on straight portions 41, internal radii 43 and external radii 42 can be made possible. In this case, a compensation can be calculated by a ratio of the tool radius R1 to the radius of curvature R2 of the workpiece 4, and/or the ratio of the current engagement length L to the engagement length LG of the tool 2 in the circumferential direction in the oversize 40 of the workpiece 4. A correction can then be carried out by means of an adjustment of a relative speed FB between the tool 2 and the workpiece 4 and/or a correction of tool path 7.

The correction constants of all formulas can for example be determined empirically and stored in the control unit 10 of the machine tool 1. In this case, it is also possible that the control unit 10 is configured as a learning system and, with each machining operation, allows for an adjustment of the correction constants for improved balancing of the deflection of the tool 2 upon engagement in the workpiece 4.

Furthermore, further parameters for individual tools 2 and/or tool types can be stored in the control unit 10 of the machine tool 1, and used for compensation of the deflection of the tool 2. For example, all the correction constants can also be dependent on the tool geometry, in particular a length of the shaft and/or conicity of the shaft and/or diameter of the shaft, the type of the tool 2, the quality of the cutting of the tool 2 or a granulation of the tool 2, the size of the oversize of the workpiece 4, a rotational speed of the tool 2, a desired speed of the contact point 6, and/or the material of the workpiece 4.

It is furthermore possible for the control unit 10 to be configured to take into account a future course of the workpiece surface in the machining direction of the tool 2 relative to the workpiece 4, which workpiece surface is still to be machined. In particular transition regions at transition points 8 between straight portions 41 and curved portions 42, 43, or between curved portions having changing radii of curvature R2, can be taken into account.

If a tool 2 is intended to be moved along the tool path 7, in FIG. 5 or FIG. 7, and for this purpose the corrected tool path 7′ is calculated using formula 2, the exact current engagement length L can be calculated for each contact point 6 between the tool 2 and workpiece 4.

It can be seen in particular from FIG. 5 that the current engagement length L does not change abruptly when the contact point 6 reaches a transition point 8, but rather that the current engagement length L begins to change continuously, already shortly before the contact point 6 reaches the transition point 8, until, upon the contact point 6 reaching the transition point 8, the value L=LG is set for the following straight portion 41.

The situation is the same when the tool 2 is moved from a straight portion 41 into an external radius 42. Already before the contact point 6 has reached the transition point 8, the current engagement length L begins to reduce, until, when the contact point 6 reaches the transition point 8, said length assumes the value resulting for the radius of curvature R2 in the external radius 42. The situation is equivalent in the case of exact use of formula 2 in transitions in internal radii. This behavior is desired in order that no abrupt changes in the path correction occur, which may lead to markings on the workpiece, even if the correction values for the path are relatively small.

If the corrected tool path 7′ is calculated using the radius R1 of the tool 2 and the radius of curvature R2 of the workpiece 4, according to formula 1 or formula 5, a continuous, gradual change of the path correction can be provided by a corresponding smoothing in the control unit 10, such that correction jumps at transition points 8 in the corrected tool path 7′ are prevented.

Since it is not necessarily the case that the oversize 40 has a constant thickness D everywhere on the workpiece 4, it is preferably provided to measure the thickness D of the oversize 40 everywhere on the workpiece 4 prior to the machining. This has the advantage, in particular in the calculation of the compensation of the deflection of the tool 2 using formula 2, formula 4, formula 6 or formula 8, that the current engagement length L can be determined for each contact point 6 between the tool 2 and workpiece 4, depending on the measured thickness D of the oversize 40, and the compensation is more precise. If the current engagement length determined on the basis of the thickness D of the oversize 40 is L<LG, then when calculating a corrected tool path 7′ formula 2, with the associated correction constants, is used, and if the current engagement length, thus determined, is L>LG or L=LG, the formula 6, with the associated correction constants, is used. The selection of the formula then no longer depends on whether it is an external radius 42 or an internal radius 43, but rather on the ratio L/LG.

The same applies when the speed FB of the contact point 6 is calculated in a manner dependent on the current engagement length L according to formula 4 or formula 8. In this case, too, the selection of the corresponding formula is determined according to the ratio of L/LG.

LG is then no longer the current engagement length L on a straight portion 41, but rather the current engagement length L for which the correction value SG for the tool path 7 or the speed FB0 of the contact point 6 optimally compensates the deflection of the tool 2.

In addition to the above written description of the disclosure, for the supplementary disclosure thereof reference is hereby explicitly made to the illustration of the disclosure in FIGS. 1 to 8.

Various features of the disclosure are set forth in the following claims.

1. A method for compensating deflection of a tool (2) during machining of a workpiece (4) using a machine tool (1), the method comprising:
balancing, via a control unit (10) of the machine tool (1), the compensation of the deflection differently in straight portions (41) and in curved portions (42, 43) depending on a dimension E of engagement conditions in a contact point (6) between the tool (2) and the workpiece (4), on a basis of one or more of:
a) a ratio of a tool radius R1 and a radius of curvature R2 of the workpiece (4) according to a formula
$$E = R 1 / R 2$$
and
b) a ratio of a current engagement length L of the tool (2) in a circumferential direction on the workpiece (4) and an engagement length LG of the tool (2) in the circumferential direction on the workpiece (4) during machining of a straight portion (41) of the workpiece (4) according to a formula E=L/LG.

2. The method according to claim 1, wherein the control unit (10) is configured to perform the compensation of the deflection of the tool (2) during machining by means of an adjustment of a relative speed FB between the tool (2) and the workpiece (4).

3. The method according to claim 2, further comprising calculating a speed (FB) of the contact point (6), during the machining of an external radius (42) of the workpiece (4) using one or more of:
a) a formula
$$FB = FB 0 + FK \cdot {E}^{k}$$
with the dimension E as the ratio of the tool radius R1 to the radius of curvature R2, wherein FB0 is a value for the speed of the contact point (6) on the straight portion (41), FK is a first correction constant, and k is a second correction constant, and
b) a formula
$$FB = FB 0 + FK \cdot {( 1 - E )}^{k}$$
with the dimension E as the ratio of the current engagement length L to the engagement length LG on the straight portion (41), wherein FB0 is a value for the speed of the contact point (6) on the straight portion (41), FK is a first correction constant, and k is a second correction constant.

4. The method according to claim 2, further comprising calculating the speed (FB) of the contact point (6), during the machining of an internal radius (43) of the workpiece (4) using one or more of:
a) the formula
$$FB = FB 0 - FK \cdot {E}^{k}$$
with the dimension E as the ratio of the tool radius R1 to the radius of curvature R2, wherein FB0 is a value for the speed of the contact point (6) on the straight portion (41), FK is a first correction constant, and k is a second correction constant, and
b) the formula
$$FB = FB 0 - FK \cdot {( E - 1 )}^{k}$$
with the dimension E as the ratio of the current engagement length L to the engagement length LG on the straight portion (41), wherein FB0 is a value for the speed of the contact point (6) on the straight portion (41), FK is a first correction constant, and k is a second correction constant.

5. The method according to claim 1, wherein the control unit (10) is configured to perform the compensation of the deflection of the tool (2) during machining by means of a correction of a tool path (7).

6. The method according to claim 5, further comprising calculating a correction value S for the tool path (7) during machining of an external radius (42) using one or more of:
a) a formula
$$S = S G - SR \cdot {E}^{k}$$
with the dimension E as the ratio of the tool radius R1 to the radius of curvature R2, wherein SG is the correction value for the tool path (7) on straight portions (41) of the workpiece (4), SR is a first correction constant, and k is a second correction constant, and
b) a formula
$$S = S G - SR \cdot {( 1 - E )}^{k}$$
with the dimension E as the ratio of the current engagement length L to the engagement length LG on the straight portion (41), wherein SG is a correction value for the tool path (7) on straight portions (41) of the workpiece (4), SR is a first correction constant, and k is a second correction constant.

7. The method according to claim 5, further comprising calculating a correction value S for the tool path (7) during machining of an internal radius (43) using one or more of:
a) a formula
$$S = S G + SR \cdot {E}^{k}$$
with the dimension E as the ratio of the tool radius R1 to the radius of curvature R2, wherein SG is the correction value for the tool path on straight portions (41) of the workpiece (4), SR is a first correction constant, and k is a second correction constant, and
b) a formula
$$S = S G + SR \cdot {( E - 1 )}^{k}$$
with the dimension E as the ratio of the current engagement length L to the engagement length LG on the straight portion, wherein SG is a correction value for the tool path (7) on straight portions (41) of the workpiece (4), SR is a first correction constant, and k is a second correction constant.

8. The method according to claim 1, wherein the control unit (10) is configured to take into account, during the compensation of the deflection of a tool (2), a course of a workpiece surface which is still to be machined by the tool (2).

9. The method according to claim 6, wherein the control unit (10) is configured to perform the compensation of the deflection of the tool (2) during machining by means of an adjustment of a relative speed FB between the tool (2) and the workpiece (4), and wherein the control unit (10) is configured to determine transition points (8) at which a geometry of the workpiece surface changes from a straight portion (41) into a curved portion (42, 43) and vice versa, or the curvature of a curved portion (42, 43) changes, and to begin a continuous change in the compensation prior to reaching a transition point (8) through the contact point (6), such that one or more of the speed FB and the correction value S for a portion behind the transition point (8) is reached in the transition point (8), and jump-like changes in the speed FB or the correction value S are prevented.

10. The method according to claim 1, wherein the control unit (10) is further configured to perform one or more of:
the compensation of the deflection of the tool (2) taking into account the length of the tool (2) in an axial direction of the tool (2),
the compensation of the deflection of the tool (2) taking into account a geometry of a tool shaft (20) of the tool (2), and
the compensation of the deflection of the tool (2) taking into account an axial engagement length of the tool (2) on the workpiece (4) in the axial direction of the tool (2).

11. The method according to claim 3, wherein the correction constants are dependent on one or more of: a type of the tool (2), a quality of a cutting edge, a material and a granulation of the tool (2), an oversize (40) of the workpiece (4), a rotational speed of the tool (2), a speed of the contact point (6), and the material of the workpiece (4).

12. The method according to claim 3, wherein the control unit (10) comprises a memory, in which values for the correction constants are stored, and wherein the method further comprises adjusting the values for the correction constants continuously, in particular by means of a learning system of the control unit (10).

13. The method according to claim 1, further comprising measuring a thickness D of an oversize (40) of the workpiece (4) at any number of locations on the workpiece (4) prior to final machining.

14. The method according to claim 1, wherein, when the dimension E is calculated as the ratio of the tool radius R1 to the radius of curvature R2 of the workpiece (4), the control unit (10) is configured to take into account a thickness D of an oversize (40) for the compensation of the deflection, or wherein the control unit (10) is configured to take into account the thickness D of the oversize (40) for calculating the current engagement length L of the tool (2).

15. A machine tool (1) which is configured to carry out a method according to claim 1.
